(19) United States
(12) Patent Application Publication
(10) Pub. No.: US 2007/0293297 A1
(43) Pub. Date: Dec. 20, 2007

(54) Slot Machine to Tabulate and Display Winning Combinations

(76) Inventor: David Schugar, Crown Point, IN (US)

Correspondence Address: MUSKIN & CUSICK LLC, 30 Vine Street, SUITE 6, Lansdale, PA, 19446, US

(21) Appl. No.: 11/423,951

(22) Filed: Jun. 14, 2006

(51) Int. Cl. A63F 13/00

(52) U.S. Cl. 463/20

(57) ABSTRACT

A slot machine game which can receive payment for a block of spins and then spin the block of spins automatically. The results of the spins can be tabulated and winning spins can be displayed to the user, thereby eliminating the necessity to display non-winning spins. The results of the spins can also be displayed to the player in a graph.

### BACKGROUND OF THE INVENTION

1. Field of the Invention

The present general inventive concept is directed to a method, apparatus, and computer readable storage medium directed to a slot machine that can generate spins and tabulate the results.

2. Description of the Related Art:

Slot machines are a billion dollar industry, both in the U.S. and around the world. Currently, a player must deposit money and spin the slot machine and view the results. The majority of slot pulls do not result in a win. Thus, players spend a lot of their time viewing losing results, which is less entertaining than winning.

What is needed is a slot machine that can allow a player to play and/or view results in a more entertaining and exciting fashion.

### SUMMARY OF THE INVENTION

It is an aspect of the present invention to provide flexibility and innovations in slot machine play.

The above aspects can be obtained by a method that includes (a) determining results of a plurality of slot machine spins; (b) displaying the results; (c) tabulating the results into tabulated results; and (d) displaying the tabulated results.

The above aspects can also be obtained by a method that includes (a) determining results for a plurality of slot machine spins; (b) identifying winning outcomes from the determined results; and (c) displaying the identified winning outcomes.

The above aspects can also be obtained by an apparatus that includes (a) a determining unit determining results for a plurality of slot machine spins; (b) an identifying unit identifying winning outcomes from the determined results; and (c) a displaying unit displaying the identified winning outcomes.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 illustrates an exemplary method of displaying slot machine spins, according to an embodiment;

FIGS. 2A-2G are sample output displays, according to embodiments;

FIG. 3 is a flowchart illustrating a method of automatically adjusting a bet size, according to an embodiment;

FIG. 4A is a graph illustrating an amount of credits possessed as a function of number of spins spun, according to an embodiment;

FIG. 4B is a graph illustrating an amount wagered per individual spin (comprising a block of spins) as a function of the number of spins spun, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage to

When players play slot machines, the play can ultimately get monotonous. The majority of slot machine spins result in losers. Players can grow bored by continuously spinning a slot machine wherein most of the spins are losers. There are typically winning spins intertwined within the losing spins, but the player must muddle through those losing spins to get to the minority of winning spins.

The present general inventive concept relates to a machine that can present results to the player in a more exciting fashion than prior art slot machines. This can be accomplished by removing losing spins from the results. This can be done by allowing the player to pre-pay (or commit to wagering) a predetermined amount of money, and then the machine can internally spin the machine until a predetermined condition is achieved. Then the results can be presented to the player. Thus, the player can be presented with his or her winning spins without having to sit through the viewing of losing spins.

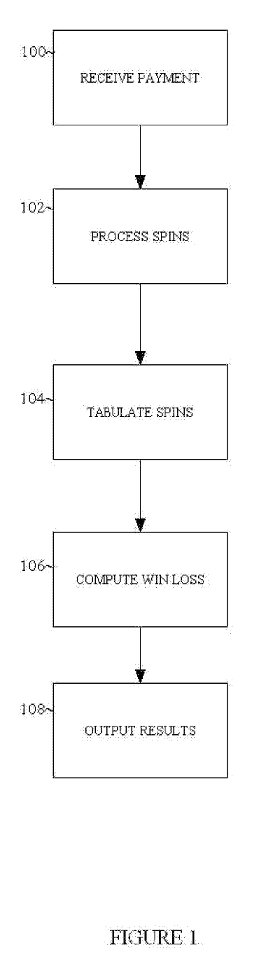

FIG. 1 illustrates an exemplary method of displaying slot machine spins, according to an embodiment.

The method can begin with operation 100, which collects the payment from the player. The player can choose how much he or she wishes to wager (or place at risk, since some original wagers can be automatically parlayed.

From operation 100, the method can proceed to operation 102, which processes a battery of spins. For example, if the player wagers $100, and each spin cost $1, then the player can be entitled to 100 spins. Thus, a cycle of 100 spins can be performed, while storing the results of each spin. Of course, any value of spins can be used and any value of initial wager can be used. Further, in a further embodiment, the number of spins is not limited to the (initial amount wagered/cost of each spin) but continuous wagers can be placed as long as a predefined criteria is met (e.g. there is still money left to wager). For example, $100 can be initially wagered, and after each spin money is deducted and possibly credited (if it is a winning spin) to the total, so that as long as money remains, automatic spins can continue. The predetermined condition can be that the total money falls within a preset range (e.g. above $0 and below $1000), although of course any numbers can be used for these parameters.

The results of each spin can be stored in numerous ways, such as in an array or block of computer memory. The array can store the spin number, the outcome of the spin (e.g. the resulting symbols), and optionally the payback of the outcome (although this can be easily calculated from the outcome using a table). This array can then be used by the system for later processing, such as the tabulation and other operations described herein. The tabulation can also be done spin by spin as well.

From operation 102 the method can proceed to operation 104, which tabulates the spins determined in operation 102. The tabulation can be performed in numerous ways. For example, all the different winning combinations can be counted to see how many of each has occurred. The spins from operation 102 can also be analyzed and the winning spins of those identified so that they can be displayed to the player.

From operation 104, the method can proceed to operation 106, which can compute the net win/loss of the spins in operation 102. This can be computed by determining a total amount of money subtracted by an initial mount of money.

From operation 106, the method can proceed to operation 108, which outputs the results. The output can be performed in numerous ways (or any combination of these ways). The frequency of wins for each possible winning combination can be displayed. Additionally (or alternatively), the winning spins can be displayed one by one to the player. For example, the first winning spin can be displayed. The player can then press the spin button (or any button), and the second winning spin can be displayed, and so on. In this way, the losing spins have been removed from the presentation.

The output of spins can be done in various orders. The spins can be ranked from highest to lowest, and thus the best spins can be presented to the player first with the lowest paying spins last. Alternatively, the lowest spins can be presented first and the highest last. Or the spins can be presented in a random order, for example the same order they were generated in operation 102.

It is noted that the operations illustrated in FIG. 1 can be performed in any sensible order. For example, operation 106 which tabulates the player win/loss may be performed in the context of operation 102, 104, or any other option. Further, operation 106 (and other operations) may be optional.

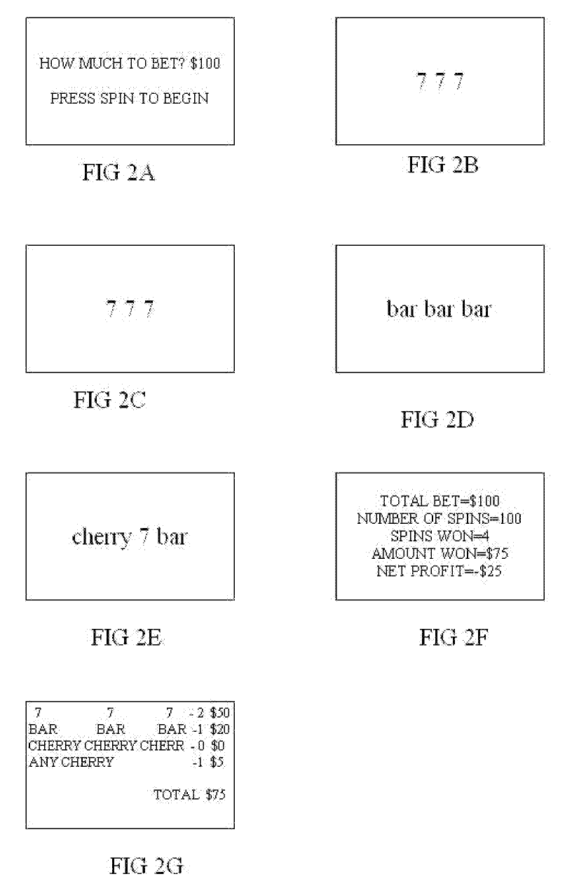

FIGS. 2A-2G are sample output displays, according to embodiments. These outputs can typically be presented during operation 108, wherein results are outputted to the player.

FIG. 2A illustrates a sample display for operation 100 from FIG. 1, which allows a player to indicate how much he or she wishes to wager on a block or series of spins. The user would typically be required to deposit the cash amount (or other deposit method) before the wager can be consummated.

FIG. 2B is an example of a winning combination the player can then be presented with. The player can then press a button to trigger the next output (or no input from the player can be required and the sequence can be progressed on a time delay). FIGS. 2C-2E represent other outputs that the machine can display. Note that this sequence is ordered from highest paying to lowest paying, although of course other orders can be used.

FIG. 2F is a sample output display displaying tabulated data for the block of spins, which can include the total amount bet (should typically be the same as in FIG. 2A), the number of spins in the block (this does not have to be directly proportional to the total amount bet since wins can be rebet as described herein), the number of winning spins, the amount won, and the net profit. FIG. 2G is a sample paytable for the game.

As a further example of one execution of a method described herein, a player can wager $5 in a slot machine. The slot machine then randomly determines the following five outcomes (wagering $1 each): 777; blank 7 blank; cherry bar bar; blank bar blank; blank blank bar (these results are all saved electronically). Assume the paytable in FIG. 2G is operative in this example. Out of the five spins, there are only two results which award a monetary amount (the first and the third). Thus, the 777 result and the cherry bar bar result are then sequentially outputted to the player (e.g. the 777 is displayed first and then the cherry bar bar displayed second, or in the opposite order) while the losing results are not displayed to the player at all (alternatively the losing spins can be displayed after the winning spins). In this manner, the player can be spared the drudgery of sitting through losing spins.

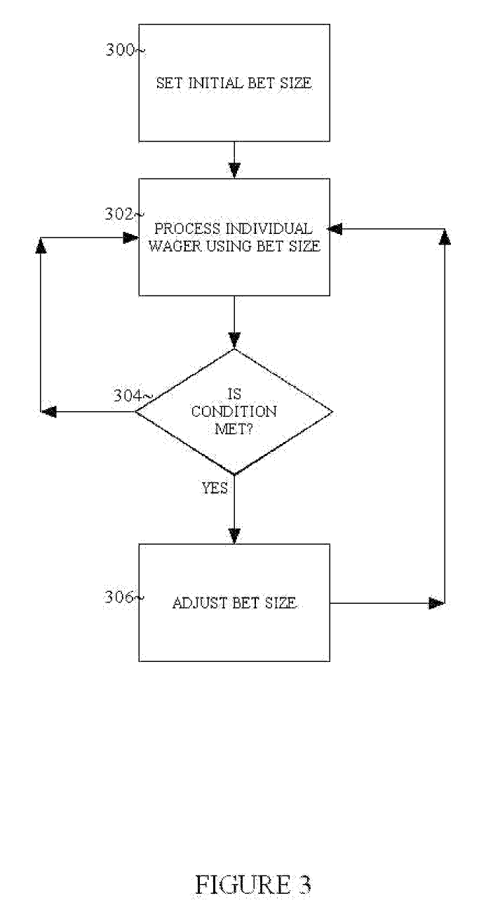

FIG. 3 is a flowchart illustrating a method of automatically adjusting a bet size, according to an embodiment.

When a block of wagers is automatically placed, the system can optionally automatically adjust a wager size. This may be beneficial to the player in that when players are winning, they typically may wish to bet more (or reinvest) while if they are losing, they typically may wish to bet less {or bet the same amount as the prior bet(s)}.

An initial wager size can be determined and an initial spin (or other game) can be performed. If the game meets a predetermined criteria, then the bet size can be adjusted based on a predetermined criteria.

Possible criteria for adjusting bet sizes can be: if the player's total credits exceeds a predetermined amount; if the player's total credits falls below a predetermined amount; if the previous spin (or other game) resulted in a win (or loss); if the previous n (e.g. 1, 2, 3, or more) spins (or other game) resulted in all wins (or losses) which can be considered “a streak”; or any other criteria based on any of the conditions of a gaming unit.

Possible criteria for determining bet sizes can be: the next bet size can be a percentage of the player's credits; the next bet size can be (or increased from the prior bet size) based on a percentage of the previous win;

A table such as that illustrated below in Table I can also be used to determine bet (or wager) sizes. Note that a plurality of such tables can each be used for a particular amount of spins (e.g. 100 at $1 each) or such a table can be used universally. Thus, using a table such as Table I, wager size is primarily a function of the player's total credits, not what the particular previous outcome(s) were (except to the extent that they change the total credits). Note that any of the values therein can be altered and the particular values are just used as examples.

TABLE I

| Total credits | amount bet |
|---|---|
| $0–$100 | $1 |
| $100–$200 | $2 |
| $200–$500 | $5 |
| $500+ | $10 |

Table II below illustrates how bets can be increased or decreased based in preceding outcomes. Such a table can be used for a particular initial wager (e.g. $1), or can be used universally. Note that any of the values therein can be altered and the particular values are just used as examples.

TABLE II

| Preceding outcome(s) | wager size adjustment |
|---|---|
| lose 2+ prior hands | decrease wager by 20% |
| lose 1 prior hand | decrease wager by 10% |
| win 1 prior hand | increase wager by 10% |
| win 2+ prior hands | increase wager by 25% |

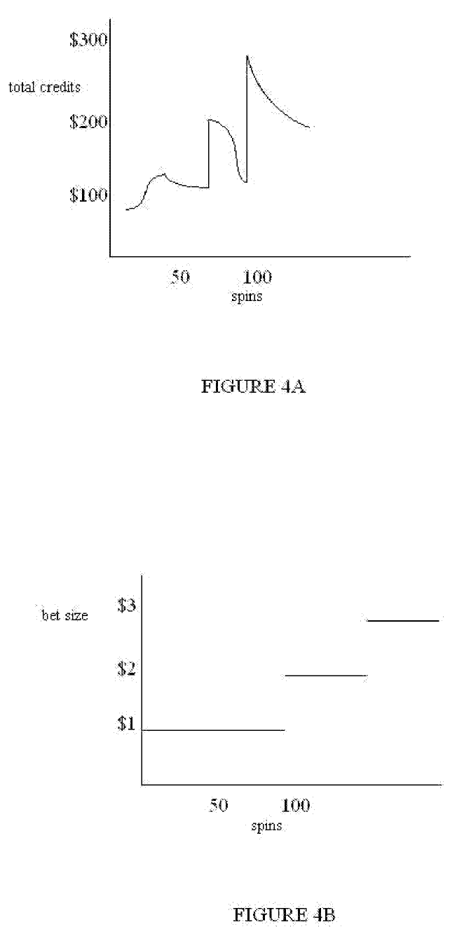

FIG. 4A is a graph illustrating an amount of credits possessed as a function of number of spins spun, according to an embodiment.

A graph can be presented to the player (either getting filled in in a temporal manner or displayed instantly all at once) of the players total credits as a function of the spin number. Thus, in the real time variation, the player can watch the graph as it goes up or down while spins are being placed automatically.

FIG. 4B is a graph illustrating an amount wagered per individual spin (comprising a block of spins) as a function of the number of spins spun, according to an embodiment.

As discussed previously, bet sizes can also vary automatically. A graph of the bet sizes can also be presented to the user, either in a real time temporal manner or all at once.

Further, the type of graph illustrated in FIG. 4A may also be presented to the player with the graph of 4B simultaneously, so that the player can view both how much he or she has and how much he or she is betting on each spin.

Many slot machine games also offer the player a bonus round. The bonus round can be earned in many known ways, such as achieving a predetermined combination. A bonus game can be thought of as a game different than the main game, wherein the player can earn monetary prizes. Using the automatic spinning as descried herein, when a bonus round is earned (if the machine offers a bonus round), the bonus round can be played automatically and the wins from the bonus round can be added to the player's credit meter, and spinning continues as described according to any of the embodiments described herein. Alternatively, the number of earned bonus rounds can be accumulated and played automatically after all the spinning has naturally ended according to any of the embodiments described herein. Alternatively, bonus rounds earned can be accumulated and then the player can then manually play all of the bonus rounds earned after all of the automatic spinning has finished.

Bonus rounds typically have an intrinsic value, typically the average award of the bonus round. The player can opt to always have the intrinsic value awarded (as opposed to playing out the bonus round) when the player earns a bonus game, or the player can be given the choice whether to take the intrinsic value or play out the bonus round. The player can also choose whether to take the bonus rounds in cash or apply any cash earned for more spins.

In an embodiment, when the player earns a bonus round, the player can choose whether to take the intrinsic value of the bonus round or more spins. For example, the player can be offered $30 for each bonus round earned or 32 more spins (at $1 each spin). Since the player is seemingly offered more money for the spins, the player may opt for the free spins even though his or her expectation on the spins may be less than $30.

Any of the choices described herein can be selected by the player on a setup screen which allows the player to configure his or her preferences. Alternatively, some or all choices can be presented to the player on a case by case basis during the block of automated spins.

It is also noted that any and/or all of the above embodiments, configurations, variations of the present invention described above can mixed and matched and used in any combination with one another. This also includes any prior document incorporated by reference, and any feature described herein can also be applied to any such documents. Any claim herein can be combined with any others (unless the results are nonsensical).

Moreover, any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
determining results of a plurality of slot machine spins;
displaying the results;
tabulating the results into tabulated results; and
displaying the tabulated results.

2. A method, comprising:
determining results for a plurality of slot machine spins;
identifying winning outcomes from the determined results; and
displaying the identified winning outcomes.

3. A method as recited in claim 2, wherein the displaying displays the winning outcomes one by one, prompted by a player.

4. A method as recited in claim 3, wherein the winnings outcomes are displayed in a sorted order.

5. A method as recited in claim 4, wherein the sorted order is from highest paying to lowest paying.

6. A method as recited in claim 4, wherein the sorted order is from lowest paying to highest paying.

7. A method as recited in claim 2, further comprising displaying a moving graph of a total amount of credits possessed while the spins are performed.

8. A method as recited in claim 2, further comprising automatically adjusting an amount wagered on each spin based on previous outcomes.

9. A method as recited in claim 8, wherein if a previous spin was a winning spin, then the adjusting increases the amount wagered.

10. A method as recited in claim 8, wherein if a previous predetermined number of spins were winning spins then the adjusting increases the amount wagered.

11. A method as recited in claim 8, wherein if a player's total credits are greater than a predetermined amount then the adjusting increases the amount wagered.

12. A method as recited in claim 8, wherein if a player's total credits are less than a predetermined amount then the adjusting decreases the amount wagered.

13. A method as recited in claim 8, wherein the adjusting adjusts the amount wagered to be the player's total credits divided by a number of remaining spins.

14. A method as recited in claim 2, wherein if a result of a slot machine spin results in a bonus game earned, converting the bonus game earned to a monetary value and continuing the determining.

15. A method as recited in claim 2, wherein if a result of a slot machine spin results in a bonus game earned, saving the bonus game until the determining is completed, upon which a player can then manually play out saved bonus game(s).

16. An apparatus, comprising:
a determining unit determining results for a plurality of slot machine spins;
an identifying unit identifying winning outcomes from the determined results; and
a displaying unit displaying the identified winning outcomes.
